(19) United States
(12) Patent Application Publication
(10) Pub. No.: US 2011/0206808 A1
(43) Pub. Date: Aug. 25, 2011

(54) Non-dairy, non-soy whippable food product and method of making

(75) Inventor: Rose Anne Colavito, Albany, NY (US)

(73) Assignee: Green Rabbit, LLC

(21) Appl. No.: 12/660,349

(22) Filed: Feb. 25, 2010

(51) Int. Cl. A23L 1/05; A23L 1/236; A23L 1/30

(52) U.S. Cl. 426/72; 426/573; 426/548

(57) ABSTRACT

A whippable food product and a method of making the same are disclosed. The finished product is packaged by an aseptic packaging process. It is shelf-stable (ingredients do not degrade or segregate during storage) at ambient temperatures for an extended period of time, and it whips stiff to form a uniform creamy topping in a short period of time. The product is free of dairy and animal products/by-products, thus suitable for vegan, kosher, or vegetarian consumption. Also, the product does not contain soy products and/or questionable ingredients such as processed oils or chemical additives, etc.

### TECHNICAL FIELD

This application relates generally to food products for human consumption. In particular, it pertains to a non-dairy, non-soy food product, and a method of making said food product.

### BACKGROUND ART

Whipped topping is a food product that is made to resemble the taste, texture, and look of whipped dairy cream. Typically, whipped topping products contain some amount of oil (including partially hydrogenated oils and/or trans fats), dairy or non-dairy protein, a sweetener, and some other ingredients. In the U.S. market, a well-known brand of whipped topping is Cool Whip®.

Whipped topping products sold in food stores are usually pre-whipped (i.e. forming an air-liquid colloid before sold to consumers), hence lightweight and voluminous, and need to be constantly refrigerated or frozen before use. Alternatively, whipped toppings may be packaged in pressurized aerosol cans, which may or may not need refrigeration. However, the aerosol-canned products typically contain nitrous oxide propellant that may have adverse health effects, and the packaging materials are non-disposable. On the other hand, since the whipped topping products typically contain dairy products, soy products, or both, people with special needs, such as kosher parve, vegan, people with high cholesterol levels, or people allergic to certain dairy or soy, may not be able to consume these products. It is now known that the restriction of, or abstention from, certain foods may have a direct impact on the health of those engaged in certain practices. Some effects have been found to be positive, as in the case of vegetarian diets, which are eaten by many Seventh-day Adventists, Hindus, Buddhists, and Rastafarians.

In recent years, some new products in the whipped topping category have been developed to reduce or eliminate unhealthy ingredients for people with certain health conditions and special needs, and to make the storage and transportation of the products more convenient and cost effective. For instance, some products now are sold as un-whipped mixtures in relatively small packages. An end user may whip the mixture into whipped topping at home. Although these products still require refrigeration, their costs of storage and transportation are lower than that of the pre-whipped products.

Various dairy-free whipped topping products are now available on the market. One example of the dairy-free whippable toppings is “Soyatoo! Whippable Soy Topping.” This product contains organic soymilk and vegetarian organic fats (manufactured in Germany and imported by Ceres Organics St. Paul, Minn., website: HYPERLINK “http://www.soyatoo.de/” http://www.soyatoo.de/). It is an un-whipped emulsion, and according to the manufacturer's instructions, must be kept under constant refrigeration. Although the manufacturer claims this product does not contain dairy products, as the name indicates, it contains soy products that may not be consumable by those allergic to soy, and it may contain processed oils like hydrogenated oils. The same company also sells two other non-dairy whipped topping products in pressurized aerosol cans, namely “Soyatoo! Soy Whip” and “Soyatoo! Rice Whip,” both of which contain nitrous oxide propellant.

Another example of non-dairy whipped topping products is “Rich's Whip Topping®” (website: HYPERLINK “http://www.whiptopping.com/products.cfm?dsp=1” http://www.whiptopping.com/products.cfm?dsp=1). This product is sold in both un-whipped and pre-whipped forms. The un-whipped product requires constant refrigeration at 0 degree Fahrenheit (−18° C.) or below prior to use. Shelf-life of the refrigerated un-whipped product is only about 12 months.

Aside from the fact that the above-mentioned whipped topping products may contain hydrogenated oils (consumption of hydrogenated oil has been linked with diabetes, coronary disease, and obesity in a number of scientific studies), they may also contain several questionable additives/ingredients such as polysorbate 60 (known to cause cancer in animals) or high fructose corn syrup (HFCS), etc. (Source: Eat Safe by Bill Statham, Running Press). Note that “questionable” is used herein to mean that there is doubt among nutrition and food experts as to the safety of consuming a particular ingredient or food product).

The reason that commonly available un-whipped topping must be kept under refrigeration is that the ingredients in the emulsified liquid mixture may degrade in ambient temperatures, thus significantly affecting its taste and reducing its shelf life. Although Perks (U.S. Pat. No. 7,351,440, assigned to Rich Products Corporation) has disclosed a topping product that can be stored at ambient temperatures for an extended period of time, and can be whipped and displayed at ambient temperatures, the formulas as disclosed therein still contain questionable additives or ingredients, hidden caseinates (from milk), and/or soy derivatives.

### SUMMARY OF THE INVENTION

In a first aspect of the invention, a method of making an emulsified mixture is provided. The emulsified mixture comprises a bulking agent, a surfactant, a gelling agent, a non-soy and non-dairy protein component, a fatty acids component, and at least one emulsifying agent. The bulking agent comprises a first sweetener. The method comprises: a) blending the gelling agent into a solution of the first sweetener dissolved in a liquefying agent; b) blending the non-soy and non-dairy protein component into the solution; c) blending the fatty acids component and the surfactant into the solution; and d) blending at least one emulsifying agent into the solution to form the emulsified mixture.

In the method, the fatty acids component may be pre-mixed with the surfactant before being blended into the solution.

Furthermore, in the method, the step d) may comprise adding two emulsifying agents into the solution.

In the method, the bulking agent may further comprise a second sweetener, and the method may further comprise: e) blending the second sweetener into the solution. It is preferable for the step e) to occur after the step b), c) or d). However, it is not intended for the invention to be limited to that order.

In the method, the emulsified mixture may further comprise a flavoring component, and the method may further comprise: f) blending the flavoring component into the solution.

The above steps a) to d), e) and f) may each be performed for a time duration of 0.5 to 10 minutes. A temperature for making the emulsified mixture may be between 80 F to 210 F.

The above method may further comprise an aseptic packaging procedure carried out in a hermetic environment. The procedure comprises: g) pasteurizing and homogenizing the mixture; h) sterilizing the mixture; and i) sealing the mixture in a sterilized container. The aseptic packaging procedure ensures that the emulsified mixture is shelf-stable for at least 18 mouths. The sterilization of the mixture may comprise heating the mixture at a high temperature for a short time. The temperature and the time may be selected as suitable for low acid liquid sterilization.

In a second aspect of the invention, an emulsified mixture is provided. The emulsified mixture comprises: a bulking agent, a gelling agent, a non-soy and non-dairy protein component, a fatty acids component, a surfactant, and at least one emulsifying agent. The bulking agent comprises a first sweetener. The emulsified mixture is prepared by a process that comprises: a) blending the gelling agent into a solution of the first sweetener dissolved in a liquefying agent; b) blending the non-soy and non-dairy protein component into the solution; c) blending the fatty acids component and the surfactant into the solution; and d) blending the at least one emulsifying agent into the solution to form the emulsified mixture.

In the emulsified mixture, the liquefying agent may be a low viscosity liquid. The low viscosity liquid may be water, milk or a non-dairy milk substitute.

In the emulsified mixture, the fatty acids component may be mixed with the surfactant before being blended into the solution. The surfactant may be a non-soy, plant-based lecithin.

In the emulsified mixture, the at least one emulsifying agent may comprise two emulsifying agents, which are added to the solution in the step d). The first and the second of the two emulsifying agents may comprise at least one of a stabilizing emulsifier and a destabilizing emulsifier. The stabilizing emulsifier may be sorbitan monostearate and the destabilizing emulsifier may be hexaglyceryl distearate.

In the emulsified mixture, the first sweetener may be one of: a natural sugar, a natural sugar substitute and an artificial sugar substitute. Further, the first sweetener may be selected from a group of natural sugars including cane sugar, beet sugar, honey, maple syrup, and agave nectar.

The emulsified mixture may further comprise a second sweetener, and the process may further comprise: e) blending the second sweetener into the solution. The second sweetener may be one of: a natural sugar, a natural sugar substitute and an artificial sugar substitute. Further, the second sweetener may be a natural sugar substitute selected from a group consisting of: maltodextrin, high fructose corn syrup, erythritol, xylitol, and maltitol. Still further, the natural sugar substitute may be maltodextrin.

The emulsified mixture may further comprise at least one flavoring component, and the process may further comprise: 0 blending the flavoring component into the solution. The flavoring component may comprise one of more of: salt, a flavoring substance, a colorant, a vitamin, and a mineral.

In the emulsified mixture, the non-soy and non-dairy protein component may be obtained from a plant-based nut or seed other than soy. The plant-based nut or seed may be one or more selected from the group: almonds, cashews, peas, macadamia nuts, pecans, Brazil nuts, pine nuts, coconut, butternuts, walnuts, beechnut, hickory nuts, chestnuts, sesame seeds, and sunflower seeds. Further, the plant-based nut or seed may be finely ground and mixed into a butter or paste form.

In the emulsified mixture, the fatty acids component may comprise one or more plant-based oils. The one or more plant based oil may be coconut oil and/or almond oil.

In the emulsified mixture, the gelling agent may be guar gum or xanthan gum.

Finally, in the emulsified mixture, the liquefying agent constitutes 42%-70% of the total weight, the bulking agent constitutes 5%-22% of the total weight, the non-soy, non-dairy protein component constitutes 0.2% to 8% of the total weight, the fatty acids component constitutes 0.25%-21% of the total weight, the gelling agent constitutes 0.05%-1.4% of the total weight, the surfactant constitutes 0.1% to 4% of the total weight, and the at least one emulsifying agent constitutes 0.1% to 4% of the total weight. It will be recognized that these disclosed ranges are not meant to be limiting, and may vary, and include without limitation, for example, any smaller range within each respective range.

### DETAILED DESCRIPTION OF THE INVENTION

The food product according to the present invention is a whippable emulsified mixture comprising several ingredients. The mixture is primarily used to form a thick cream-like topping in a post-process involving whipping (e.g., high-speed blending). The whipping causes the mixture to form an air-liquid colloid, greatly expanding in volume. The whipped topping may be used in various food products such as cakes, pastries, or desserts. However, the emulsified mixture according to the present invention may also be used for other purposes that a person skilled in the art may foresee, and these other usages should not be considered as departing from the scope of the invention.

One character of the whippable food product according to the present invention is that it can be packaged and sold in an un-whipped form. By using an aseptic packaging method, the product is shelf-stable (e.g., the ingredients do not segregate and degrade during storage) at ambient temperatures for an extended period of time (such as, without limitation, eighteen months to two years or more). Another character of the whippable food product according to the present invention is that it whips stiff to form a uniform creamy topping in a short period of time (such as, without limitation, a few minutes). Yet another character of the whippable food product according to the present invention is that the product is totally free of dairy and animal products/by-products, thus suitable for vegan, kosher parve, or vegetarian consumptions. Also, the product does not contain soy products and/or questionable ingredients such as hydrogenated oils or chemical additives that are considered unsafe by most nutrition and health food professionals.

In one embodiment, the emulsified mixture comprises the following ingredients: 1) a bulking agent; 2) a non-soy, non-dairy protein component; 3) a fatty acids component; 4) a gelling agent; 5) a surfactant, and 6) at least one emulsifying agent. The above ingredients are mixed in a liquefying agent by a process described below to form a uniform emulsified mixture. Furthermore, one or more flavoring components, vitamins and/or minerals, or colorants may be included in the mixture for the purposes of enhancing the flavor, providing nutritional values, or providing visual effects.

The following are descriptions of the ingredients according to embodiments of the invention.

### Liquefying Agent

The liquefying agent may preferably be a low viscosity liquid. One preferred candidate for the liquefying agent is purified water of any kind, such as tap water, spring water, filtered tap water, purified reverse-osmosis treated water, distilled water, de-ionized water, etc. as long as the water is suitable for food preparation. Water adds no discernible taste profile to the finished product, so it is a preferred liquefying agent. However, aside from the water, a wide variety of drinkable liquid may also be considered as the liquefying agent. Some examples may include, without limitation, milk substitutes such as almond milk, rice milk, hazelnut milk, and coconut milk. Dairy milk (all varieties) can be used for the same purpose, but for a non-dairy product, diary milk should not be used. Soy milk can also be used for the same purpose, but for a non-soy product, soy milk should not be used.

### Bulking Agent

The bulking agent comprises at least one sweetener, and may comprise two or more sweeteners. A sweetener suitable for the invention may be a natural sugar, a natural sugar substitute, or an artificial sugar substitute.

Examples of the natural sugar include, without limitation, many varieties of naturally occurring sweettasting substances mainly composed of sucrose and/or fructose, such as cane sugar, beet sugar, cane juice, beet juice, refined sugar, maple syrup or other tree syrups, honey, agave nectar, and the like.

Examples of the natural sugar substitute include, without limitation, various sweeteners produced from starches (a.k.a. starch sugars) such as maltodextrin, glucose syrups (e.g. corn syrup, rice syrup, tapioca syrup, potato syrup, etc.), dextrose, high fructose corn syrup, crystalline fructose, trehalose, sugar alcohols (e.g. xylitol, maltitol, erythritol, sorbitol, mannitol, isomalt, lactitol, etc), and the like.

Examples of the artificial sweetener include, without limitation, saccharin (e.g., Sweet'N Low), aspartame (e.g., Equal, NutraSweet), sucralose (e.g., Splenda, Altern), neotame, acesulfame potassium, stevia, polydextrose, glycerin, propylene glycol, or other monosaccharides, disaccharides, polysaccharides, polyols, and/or combinations thereof.

In one embodiment of the invention, the bulking agent may comprise a first sweetener and a second sweetener. The first sweetener may be a sugar from the above-mentioned natural sugar category. The first sweetener may give the product a sweet-tasting character resembling that of the whipped dairy cream or Chantilly cream. The second sweetener may be a sugar substitute, such as maltodextrin. Maltodextrin adds sweetness while not raising the product's glycemic index as much as sugar would, and it adds body, as it is a starch.

### Protein Component

The present invention is characterized by using one or more varieties of non-soy, non-dairy protein as its protein component. In one exemplary embodiment of the invention, the non-soy, non-dairy protein may be obtained from a plant-based nut or seed other than soy. Suitable plant-based nuts and seeds include, without limitation, almonds, cashews, macadamia nuts, pecans, Brazil nuts, pine nuts, coconut, butternuts, walnuts, beechnut, hickory nuts, chestnuts, sesame seeds, sunflower seeds, and the like.

Among the above-listed nuts and seeds, one preferred nut is almond and one preferred seed is cashew. Although not required, almonds or cashews may be organically grown and processed. Almonds may preferably be blanched to remove their outer skin. They may be whole almonds, pieced almonds, chopped almonds, or ground almonds. Cashews may preferably be raw and skinless. They may be whole cashews, pieced cashews, chopped cashews, or ground cashews. As used herein, the terms “blanched,” “raw,” and “organic” correspond to definitions familiar to those skilled in the relevant art.

For optimum results, the non-soy nut or seed may be processed before being used for the emulsified mixture. For example, almonds or cashews may be finely ground and emulsified, such as being processed into almond butter, cashew butter, almond paste, cashew paste, etc. The ground and buttered non-soy nuts or seeds are included in the whippable topping for their characteristic creamy textures, nutritional properties, neutral to slightly sweet tastes, substance and body, and protein content. The protein component of the topping mixture is known to assist emulsification and stability of the product when whipped.

In the above exemplary embodiment, almonds and cashews may be used alone, or they may be mixed together. One example is that almonds and cashews are mixed in a ratio of about 1 to 1 by weight. Another example is that almonds and cashews are mixed in a ratio of about 2 to 1 (almonds to cashews) by weight. However, it should be apparent to a person skilled in the art that the present invention is not limited by any particular ratio or range of ratios of almonds and cashews.

It is also advantageous to make use of substantially equal parts of liquefied almonds (“almond cream”) and liquefied cashews (“cashew cream”) to form the protein component.

As such, the non-soy, non-dairy nut/seed protein component substantially replaces dairy- or soy-based protein components in the whippable topping product. The resulting food composition is a viable alternative for those who are lactose intolerant, or who wish to avoid products containing soy or dairy.

Aside from the above mentioned non-soy nut or seed protein sources, other suitable protein sources may also be considered, which include, without limitation, vegetable proteins, such as pea protein, potato protein, lentil protein, bean proteins, etc. and protein isolates.

### Fatty Acids Component

In the present invention, the fatty acids component comprises a plant-based oil extracted from plants, plant seeds, or fruits other than soy. Preferably, the plant-based oil is in its least-processed form (meaning the oil is not processed to alter its original molecular structure and composition, such as being partially hydrogenated. One suitable candidate for the natural, plant-based oil is coconut oil. Another suitable candidate is almond oil. The fatty acids component may also be a mixture of two or more kinds of least-processed, plant-based oil extracted from plants, plant seeds or fruits other than soy. One example is a mixture of coconut oil and almond oil. A ratio of coconut oil to almond oil, without limitation, may be from 14-1 to 8-1. The fatty acids component contributes to the stability of the emulsified topping mixture.

Other possible candidates for the fatty acids component include, but are not limited to, olive oil, vegetable oil, corn oil, rapeseed oil, sunflower oil, corn oil, peanut oil, cotton oil, palm oil, and palm kernel oil, etc. It will be noted that soybean oil could also potentially be used, however, would not be suitable for a non-soy embodiment.

### Gelling Agent

The gelling agent is used in the present invention for thickening and stabilizing the whippable topping mixture. In one embodiment of the invention, the gelling agent may be a food additive polysaccharide, such as guar gum, xanthan gum, or other natural-origin gum systems known in the art. The gelling agent may also comprise, without limitation, one or more from the group: Carrageenan, acacia gum, agar, alginates, MCC (micro-cystalline cellulose), CMC (carboxymethyl cellulose), locust bean gum, Inulin, and Pectin.

### Surfactant and Emulsifying Agents

The whippable topping product of the present invention further comprises one or more substances for forming and stabilizing the emulsified mixture. In one embodiment of the invention, the whippable topping product comprises a low-water solubility surfactant. This low-water solubility surfactant may be blended into the solution with the fatty acids component, with either the fatty acids component added first, and then the surfactant, or vice versa. It is also possible for the surfactant and the fatty acids component to be added alternating with one another, or preferably, mixed together to form a mixture, which may then be added to the other ingredients. Examples of the surfactant include various lecithin, such as vegetable lecithin, sunflower lecithin, or grape seed lecithin. Soy lecithin can also been used for the same purpose, but for a non-soy product, soy lecithin should not be used. Overall, in the whippable topping mixture of the present invention, the surfactant may act as a destabilizing emulsifier. It helps to reduce the viscosity of the mixture and helps to disperse the components evenly.

Aside from the surfactant, the whippable topping product of the present invention may further comprise at least one emulsifying agent. In one embodiment of the invention, the at least one emulsifying agent may further comprise one or more components, such as a stabilizing emulsifying agent and a destabilizing emulsifying agent. The stabilizing emulsifying agent preferably comprises hexaglyceryl distearate. Also, a variety of other stabilizing emulsifying agents may, alone or in combination, be substituted for or used in addition to hexaglyceryl distearate, for example, without limitation, saturated monoglycerides, saturated diglycerides, polyglycerol esters of fatty acids, cellulose gums, sucrose esters, and/or sodium stearoyl lactylate. The destabilizing emulsifying agent preferably comprises sorbitan monostearate. Also, a variety of other destabilizing emulsifying agents may, alone or in combination, be substituted for or used in addition to sorbitan monostearate, for example, without limitation, unsaturated monoglycerides, unsaturated diglycerides, propylene glycol esters, sorbitan monostearate, polysorbate 65, polysorbate 60 and polysorbate 80, lecithin, and sodium stearoyl lactylate.

Other emulsifiers or emulsifying agents known in the art that may be considered for the present invention include various fat-based emulsifiers (hydrogenated or partially hydrogenated fat-based emulsifiers, non-hydrogenated fat based emulsifiers, and modified fat-based emulsifiers) such as lecithin and hydroxylated lecithin; various mono, di, or polyglycerides of fatty acids, such as stearin and palmitin mono and diglycerides; polyoxyethylene ethers or fatty esters of polyhydric alcohols, such as the polyoxyethylene ethers of sorbitan monostearate (polysorbate 60, 65, 80) or the polyoxyethylene ethers of sorbitan distearate; fatty esters of polyhydric alcohols such as sorbitan monostearate; polyglycerol esters of mono and diglycerides such as hexaglyceryl distearate; mono- and diesters of glycols such as propylene glycol monostearate, and propylene glycol monopalmitate, succinoylated monoglycerides; and the esters of carboxylic acids such as lactic, citric, and tartaric acids with the mono- and diglycerides of fatty acids such as glycerol lacto palmitate and glycerol lacto stearate; and calcium or sodium stearoyl lactylates and all members of the sucrose ester family thereof; all varieties of diacetyltartaric esters of fatty acids; “DATEMS”; and distilled lactylated or acetylated monglycerides.

Among the above mentioned fat-based emulsifiers, non-hydrogenated fat-based emulsifiers are preferred. The term “non-hydrogenated fat-based emulsifier” used herein means emulsifiers which are derived from a non-hydrogenated fat or oil source and include lecithin (a natural emulsifier derived from animal or vegetable sources), distilled monoglycerides and mono and diglyceride blends. The preferred non-hydrogenated fat-based emulsifier may be a distilled monoglyceride from a plant-based oil or fat.

### Flavorings and Other Components

Although not considered to be essential for achieving the objectives of the invention, a variety of additional components may be added to the whippable topping product of the present invention for enhancing the taste, nutritional value, and appearance of the product. In one embodiment of the invention, the additional components may comprise flavoring components such as salt and other natural flavorings used alone or in combination, e.g., without limitation, vanilla extract, vanilla bean, chocolate, raw ground fresh fruit, hazelnut, mint extracts (peppermint, spearmint, wintergreen, etc.), lemon juice, lemon rind, orange juice, orange rind, shredded unsweetened coconut, butter, caramel, toffee, coffee, maple, cream, and/or other natural or artificial flavorings. Some examples of types of chocolate, which can be used, without limitation, may include chocolate, cocoa, unsweetened chocolate, semi-sweet chocolate, bittersweet chocolate, cocoa mast, cocoa nibs, and unsweetened cocoa. Some examples of raw ground fresh fruit, which can be used, without limitation, may include strawberries, peaches, raspberries, blueberries, blackberries, cloudberries, bananas, papayas, mangoes, nectarines and cherries. Salt, in addition to providing flavor, acts as a buffer and sequestrant. Examples of useful salts are common salt (sodium chloride), and sodium, calcium or potassium monophosphates, diphosphates, polyphosphates, citrates, chlorides, and the like.

Other ingredients that may be used in the present invention may include colorants, vitamins, and minerals. These ingredients are known in the art and hence are not discussed further herein.

As a non-restrictive example, Table 1 lists the approximate weight percent ranges for each component of a whippable topping product according to the present invention. It will be recognized that these disclosed weight percentage ranges listed in Table 1 are not meant to be limiting, and may vary, and include without limitation, for example, any smaller range within each respective range.

TABLE 1
Weight Percent Ranges for Components of the Whippable Topping
Mixture

| Component | Weight Percentage Range |
|---|---|
| Liquefying Agent | 42%-70% |
| Bulking Agent | 5%-22% |
| Protein Components | 0.2%-8% |
| Fatty Acids Components | 0.25%-21% |
| Surfactant | 0.1%-4% |
| Gelling Agent | 0.05%-1.5% |
| Emulsifying Agent(s) | 0.1%-4% |
| Other Components | 0.01%-1% |

It should be noted that the percentages shown in Table 1 are not limiting in any way and may be adjusted by those skilled in the art without departing from the scope of the invention.

In one embodiment of the invention, the inventive whippable topping mixture has been subjected to a packing procedure for being packed into finished products. The packing procedure may vary depending on the manufacturing conditions.

A process of Making the Emulsified Mixture and the Whippable Topping

According to a preferred embodiment of the present invention, a process for making the emulsified mixture comprises the following steps:
a) blending a gelling agent into a solution, the solution comprising a bulking agent dissolved in a liquefying agent;
b) blending a non-dairy, non-soy protein component into the solution;
c) blending a fatty acids component and a surfactant into the solution; and
d) blending at least one emulsifying agent into the solution to form the emulsified mixture.

It should not be construed that the above steps a) to d) must be carried out in the order as indicated, although it is preferred to carry out the steps a) to d) in that order.

In the above process, the mixing equipment may be a blender, a turbo mixer, or any commonly available mechanical device suitable for mixing food ingredients. It is preferred that the process is carried out in an elevated temperature. For example, the mixing equipment may be pre-warmed to the elevated temperature. The elevated temperature may be, for example, without limitation, approximately 120 degrees F. (˜50° C.). It will be recognized that 120 degrees F. has been chosen for the purposes of disclosure, but is in no way meant to be limiting. The invention comprises any suitable temperature, which may be recognized by one skilled in the art. Warming up the mixing equipment may be accomplished by many different ways, for example, adding boiling water into the mixing equipment to raise the temperature, and then pouring off the water.

In the above process, the solution of the bulking agent dissolved in the liquefying agent may be obtained by adding a first sweetener into the liquefying agent in the pre-heated mixing equipment and blending until the first sweetener is completely dissolved. It is also preferred that the liquefying agent is pre-heated to a temperature slightly below the boiling point, for example, without limitation, about 200 degrees F. (˜93° C.). It will be recognized that 200 degrees F. has been chosen for the purposes of disclosure, but is in no way meant to be limiting. The invention comprises any suitable temperature which may be recognized by one skilled in the art.

In the above process, it is preferable for the fatty acids component to be pre-heated to a temperature at which it is in its liquid state prior to being mixed with the surfactant or bleneded directly into the solution. Without being limited to the theory, it is believed that such temperature and state allows the fatty acids component to disperse more quickly and evenly. It will be recognized that this is in no way meant to limit the invention, and a fatty acids component in a state other than liquid is still included within the scope of the invention.

The above process may further comprise a step of: e) blending a second sweetener into the solution. Preferably, the step e) is performed after the step b), c), or d).

In step d) of the method, the at least one emulsifying agent of the emulsified mixture may comprise a first emulsifying agent and a second emulsifying agent. It is preferable that this sub-step comprises adding a stabilizing emulsifying agent, and adding a destabilizing emulsifying agent. The stabilizing emulsifying agent and destabilizing emulsifying agent may be added either together (either mixed together and then added to the solution; or simply added at the same time to the solution) or in tandem, and if in tandem, the stabilizing agent may be added before the destabilizing agent or vice versa.

The above process may further comprise a step of: f) blending one or more other components into the solution.

Some or all of the above steps a) to f) may be combined. Each of the above steps a) to f) (or combinations thereof) may be performed for a time duration of a few minutes, respectively. Typically, without limitation, the time period may be approximately 0.5-10 minutes. It will be recognized that this disclosed range is not meant to be limiting, and may vary, and include without limitation, for example, any smaller range within the disclosed range.

The emulsified mixture obtained from the above-described process may further undergo a packaging procedure for being packed into finished products. The packaging procedure varies depending on the manufacturing conditions. For example, in a mass production environment, an aseptic packing procedure may be carried out. Typically, this aseptic procedure may comprise the following steps:
g) pasteurizing and homogenizing the mixture in a hermetic environment (i.e. under vacuum or inert atmosphere);
h) sterilizing the mixture in the hermetic environment; and
i) sealing the sterilized mixture in a sterilized container in the hermetic environment.

The sterilization of the mixture may be carried out by e.g. a “high temperature, short time” (HTST) process. The temperature and the time may be selected according to the parameters suitable for low-acid liquid sterilization. The emulsified mixture prepared according to the aseptic packaging process can be stored at ambient temperatures. Testing results show that the aseptically packaged mixture can have a shelf life of at least eighteen months without losing freshness, taste, and characteristics. Aseptic packaging processes and HTST are believed to be well-known to those of skill in the art, and are not further disclosed herein.

In other manufacturing conditions, e.g. while not in the aseptic process environment, the emulsified mixture prepared by the above-disclosed process may undergo an alternative post-process procedure comprising one or more of the following steps (i.e. without following the aseptic procedure as in steps g) through i) above):
j) heating the mixture to an elevated temperature while stirring the mixture constantly;
k) after reaching said elevated temperature, blending the mixture; and
l) packing the mixture in a sterilized container.

For example, in the above step k), the blending is performed at a high speed for a period of time that is, without limitation, 0.5-10 minutes. The heating and/or blending actions are believed to activate the starches in the mixture, equivalent to pasteurization and homogenization. Test results show that in ambient temperatures, the finished product has a shelf life shorter than that of the ones processed by the aseptic packing procedure. Therefore, refrigeration may be required. However, the product still has other characteristics, such as it can be whipped to form the whipped topping in a short time and the taste and volume expansion are not affected.

### Examples

Having disclosed the process in general, a particular exemplary process for making the emulsified mixture according to one embodiment of the invention may comprise the following actions:
(1) In a pre-warmed blender or turbo mixer, adding pre-heated liquefying agent (e.g. water);
(2) To water, adding the first sweetener (e.g. sugar or cane solids), and blending for 2 minutes;
(3) To the mixture, adding the gelling agent (e.g. guar gum), and blending for 2 minutes;
(4) To the mixture, adding non-soy protein (e.g. almond and cashew butters or pastes), and blending for 2 minutes;
(5) To the mixture, adding the second sweetener (e.g. maltodextrin), and blend for 1 minute;
(6) To the mixture, adding the pre-heated liquid-state fatty acids component (e.g. coconut and almond oils pre-mixed with lecithin), and blending for 1 minute;
(7) To the mixture, adding the emulsifying agent (e.g. hexaglyceryl distearate and/or sorbitan monostearate), and blending for 2 minutes; and
(8) To the mixture, adding other components (e.g. flavorings and/or salt), and blending for 1 minute.

The emulsified mixture is then packed as finished products. For example, the above exemplary mixture-making process (steps 1-8) may continue with the following aseptic package process:
(9) Transferring the mixture to an aseptic process equipment under vacuum or inert atmosphere, pasteurizing the mixture at a high temperature above the water boiling point (e.g., 285-295 degrees F.) for a few seconds (e.g., 8 seconds), and, after slightly cooling, homogenizing the mixture;
(10) Sterilizing the mixture under vacuum or inert atmosphere using e.g. a “high temperature, short time” process suitable for sterilizing low acid liquids; and
(11) Packing the mixture into a sterile container.

Alternatively, as mentioned above in a non-aseptic packing process, the steps (9) to (11) may be replaced by the following steps:
(12) Transferring the mixture to a container (e.g., a kettle), and heating it to an elevated temperature (for example, without limitation, 190 degrees F.) while stirring the mixture constantly;
(13) After reaching said elevated temperature, transferring the mixture to blending equipment (e.g., a blender) and blending the mixture at a high speed for 1-2 minutes; and
(14) Packing the mixture in a container.

After, for example, purchasing the packaged product, an end user may follow the following steps to prepare the whipped topping:
1. Refrigerating the emulsified mixture in cartons for a sufficient amount of time for the product to chill (e.g., reach 45 degrees F.); and
2. Pouring the contents from the carton and whipping with a suitable method (e.g., using a hand-held beater, a whip or an electric mixer or beater) for 30 seconds to 3 minutes, the desired stiffness of the whipped topping can be achieved.

It has been found that the volume expansion of the whipped topping is about 200-400% (i.e. half cup of the mixture can be whipped into approximately 1-2 cups or more of whipped topping).

Table 2 shows exemplary ingredients of each component of the mixture, along with preferred weight percentage ranges.

TABLE 2
Weight Percent Ranges for Ingredients of the Whippable Topping Mixture

| | | Wt | Preferred wt % |
|---|---|---|---|
| Component | Exemplary Ingredient | % Range | Range |
| Liquefying Agent | Water | 42-70 | 50-52 |
| Bulking Agent | Sugar | 6-22 | 12.5-14.2 |
| | Maltodextrin | 5-19 | 8-10 |
| Protein | Almond | 0.2-8 | 0.9-2.9 |
| Components | | | |
| | Cashew | 0.2-8 | 0.9-2.9 |
| Fatty Acids | Almond Oil | 0.25-3 | 1.2-2.2 |
| Components | | | |
| | Coconut Oil | 7-21 | 15.8-17.8 |
| Surfactant | Lecithin | 0.1-4 | 0.2-0.8 |
| Gelling Agent | Guar Gum | 0.1-2 | 0.1-0.3 |
| Emulsifying | Sorbitan Monostearate, | 0.1-4 | 0.25-0.45 |
| Agent(s) | hexaglyceryl distearate | | |
| Other Components | Salt and Flavorings | 0.01-1 | 0.25-0.45 |

Table 3 lists some composition examples according to the present invention.

TABLE 3
Example Compositions of the Whippable Topping Mixtures

| Ingredient | | | | | | | |
|---|---|---|---|---|---|---|---|
| (wt %) | Ex. 1 | Ex. 2 | Ex. 3 | Ex. 4 | Ex. 5 | Ex. 6 | Ex. 7 |
| Water | 52.28 | 62.08 | 51.58 | 61.12 | 51.74 | 62.66 | 52.17 |
| Sugar | 13.99 | 11.09 | 13.87 | 10.80 | 13.88 | 10.96 | 13.99 |
| Maltodextrin | 9.99 | 7.92 | 9.91 | 7.80 | 9.91 | 7.83 | 9.99 |
| Almond | 1.99 | 1.58 | 1.98 | 1.56 | 1.98 | 1.56 | 1.99 |
| Cashew | 1.99 | 1.58 | 1.98 | 1.56 | 1.98 | 1.56 | 1.99 |
| Coconut Oil | 16.49 | 13.08 | 16.35 | 12.80 | 16.36 | 12.92 | 16.48 |
| Almond Oil | 1.497 | 1.18 | 1.49 | 1.17 | 1.48 | 1.17 | 1.49 |
| Lecithin | 0.306 | 0.243 | 0.3 | 0.23 | 0.3 | 0.23 | 0.3 |
| Guar Gum | 0.109 | 0.17 | 0.22 | 1.71 | 0.21 | 0.17 | 0.21 |
| Emulsifying | 1.098 | 0.86 | 1.90 | 0.85 | 0.98 | 0.85 | 1.08 |
| Agent(s) | | | | | | | |
| Salt | 0.050 | 0.039 | 0.05 | 0.03 | 0.04 | 0.03 | 0.05 |
| Flavorings | 0.147 | 0.18 | 0.37 | 0.10 | 0.97 | 0.06 | 0.14 |

In summary, the present application provides a non-dairy, non-soy food product. The food product can be whipped to form a whipped topping. This product can be packaged and sold in an un-whipped form by regular aseptic packaging. This product is shelf-stable at ambient temperatures for at least two years, and it whips stiff to form a uniform creamy topping or frosting (after being briefly refrigerated) in less than one minute. The product is totally free of dairy and animal products/by-products, thus it is suitable for consumption by people with special dietary needs. Also, the product does not contain soy products and/or questionable ingredients such as processed oils, chemical additives, etc.

The product of the present invention greatly alleviates the need for storage space in freezers or refrigerators, which are both considered prime “real-estate” in any kitchen or food service facility. It is also truly non-dairy and contains no additives of “questionable nature”.

The finished product of the present invention can be sold as a food product at supermarkets or health food stores. The closest products to this invention shown in the prior art would all contain soy or dairy derivatives or unwanted additives/ingredients, and most would need refrigeration or freezing. Any health-conscious, kosher or vegan consumer, any lactose-intolerant or gluten-intolerant consumer, any consumer who was also looking to avoid soy in their foods can advantageously use the product resulted from the present invention.

As used herein, an element or step recited in the singular and proceeded with the word “a” or “an” should be understood as not excluding plural elements or steps, unless such exclusion is explicitly stated. Furthermore, references to “one embodiment” or “preferred embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Since other modifications and changes varied to fit particular usages will be apparent to those skilled in the art, the invention is not considered limited to the embodiment chosen for purposes of disclosure, and it covers all changes and modifications which do not constitute departures from the true spirit and scope of this invention.

Having thus described the invention, what is desired to be protected by Letters Patent is presented in the subsequently appended claims.

1. A method for making an emulsified mixture,
wherein the emulsified mixture comprises a bulking agent, a gelling agent, a non-soy and non-dairy protein component, a fatty acids component, a surfactant, and at least one emulsifying agent,
wherein the bulking agent comprises a first sweetener, and
wherein the method comprises:
a) blending the gelling agent into a solution of the first sweetener dissolved in a liquefying agent;
b) blending the non-soy and non-dairy protein component into the solution;
c) blending the fatty acids component and the surfactant into the solution; and
d) blending at least one emulsifying agent into the solution to form the emulsified mixture.

2. The method of claim 1, wherein the fatty acids component and the surfactant are premixed prior to being blended into the solution in step c).

3. The process of claim 1 wherein the fatty acids component is pre-heated prior to being blended into the solution in step c).

4. The method of claim 1, wherein the bulking agent further comprises a second sweetener, and the method further comprises:
e) blending the second sweetener into the solution.

5. The method of claim 1, wherein the at least one emulsifying agent in step d) comprises two emulsifying agents.

6. The method of claim 1, wherein the emulsified mixture further comprises a flavoring component, and the method further comprises:
f) blending the flavoring component into the solution.

7. The method of claim 1, wherein the steps a) to d) are each performed for a time duration of 0.5 to 10 minutes.

8. The method of claim 1, wherein a temperature for making the emulsified mixture is between 80 F to 210 F

9. The method of claim 6, further comprising:
g) pasteurizing and homogenizing the mixture in a hermetic environment;
h) sterilizing the mixture in the hermetic environment; and
i) packing the sterilized mixture in a sterilized container in the hermetic environment.

10. The method of claim 9, wherein sterilizing the mixture comprises sterilizing the mixture according to a procedure suitable for sterilizing low-acid liquids in the hermetic environment.

11. An emulsified mixture, comprising:
a bulking agent,
a gelling agent,
a non-soy and non-dairy protein component,
a fatty acids component,
a surfactant, and
at least one emulsifying agent,
wherein the bulking agent comprises a first sweetener, and
wherein the emulsified mixture is prepared by a process that comprises:
a) blending the gelling agent into a solution of the first sweetener dissolved in a liquefying agent;
b) blending the non-soy and non-dairy protein component into the solution;
c) blending the fatty acids component and the surfactant into the solution; and
d) blending at least one emulsifying agent into the solution to form the emulsified mixture.

12. The emulsified mixture of claim 11, wherein the liquefying agent is a low viscosity liquid.

13. The emulsified mixture of claim 12, wherein the liquefying agent is water, milk or a non-dairy milk substitute.

14. The emulsified mixture of claim 11, wherein in the process the surfactant and the fatty acids component are mixed together prior to being blended into the solution in step c).

15. The emulsified mixture of claim 11 wherein the fatty acids component is pre-heated prior to being blended into the solution in step c) of the process.

16. The emulsified mixture of claim 14, wherein the surfactant is a non-soy, plant-based lecithin.

17. The emulsified mixture of claim 11, wherein the first sweetener is at least one of a natural sugar, a natural sugar substitute and an artificial sugar substitute.

18. The emulsified mixture of claim 17, wherein the first sweetener is selected from a group: cane sugar, beet sugar, honey, maple syrup, and agave nectar.

19. The emulsified mixture of claim 11, further comprising a second sweetener, and the process further comprises:
e) blending the second sweetener into the solution.

20. The emulsified mixture of claim 19, wherein the second sweetener is at least one of a natural sugar, a natural sugar substitute and an artificial sugar substitute.

21. The emulsified mixture of claim 20, wherein the second sweetener is selected from a group: maltodextrin, high fructose corn syrup, erythritol, xylitol, and maltitol.

22. The emulsified mixture of claim 21, wherein the second sweetener is maltodextrin.

23. The emulsified mixture of claim 14, wherein said at least one emulsifying agent comprises at least two emulsifying agents.

24. The emulsified mixture of claim 23, wherein at least one of the at least two emulsifying agents comprises a stabilizing emulsifier and at least another comprises a destabilizing emulsifier.

25. The emulsified mixture of claim 24, wherein the stabilizing emulsifier is sorbitan monostearate and the destabilizing emulsifier is hexaglyceryl distearate.

26. The emulsified mixture of claim 11, further comprising at least one flavoring component, wherein the process further comprises:
f) blending the flavoring component into the solution.

27. The emulsified mixture of claim 26, wherein the flavoring component comprises one of more of: salt, a flavoring substance, a colorant, a vitamin, and a mineral.

28. The emulsified mixture of claim 11, wherein the non-soy and non-dairy protein component is obtained from a plant-based nut or seed other than soy.

29. The emulsified mixture of claim 28, wherein the plant-based nut or seed is at least one selected from a group: almonds, cashews, peas, macadamia nuts, pecans, Brazil nuts, pine nuts, coconut, butternuts, walnuts, beechnut, hickory nuts, chestnuts, sesame seeds, and sunflower seeds.

30. The emulsified mixture of claim 29, wherein the plant-based nut or seed is finely ground and mixed into a butter or paste form.

31. The emulsified mixture of claim 11, wherein the fatty acids component comprises at least one plant-based oil.

32. The emulsified mixture of claim 31, wherein the one or more plant based oil is coconut oil and/or almond oil.

33. The emulsified mixture of claim 11, wherein the gelling agent is guar gum or xanthan gum.

34. The emulsified mixture of claim 11, having a total weight, wherein the liquefying agent constitutes 42% to 70% of the total weight, the bulking agent constitutes 5% to 22% of the total weight, the non-soy, non-dairy protein component constitutes 0.2% to 8% of the total weight, the fatty acids component constitutes 0.25% to 21% of the total weight, the gelling agent constitutes 0.5% to 1.5% of the total weight, the at least one emulsifying agent constitutes 0.1% to 4% of the total weight, and the surfactant constitutes 0.1% to 4% of the total weight.

35. The emulsified mixture of claim 14, having a total weight, wherein the liquefying agent constitutes 42% to 70% of the total weight, the bulking agent constitutes 5% to 22% of the total weight, the non-soy, non-dairy protein component constitutes 0.2% to 8% of the total weight, the fatty acids component constitutes 0.25% to 21% of the total weight, the gelling agent constitutes 0.05% to 1.5% of the total weight, the at least one emulsifying agent constitutes 0.1 to 4% of the total weight, and the surfactant constitutes 0.1% to 4% of the total weight.

36. The emulsified mixture of claim 35, further comprising salt and/or flavorings, and wherein said salt and/or flavorings constitute 0.01% to 1% of the total weight.

37. The emulsified mixture of claim 34, wherein the emulsifying agent comprises at least one of a stabilizing emulsifier and a destabilizing emulsifier.
